(19) United States
(12) Patent Application Publication
(10) Pub. No.: US 2018/0297507 A1
(43) Pub. Date: Oct. 18, 2018

(54) Vehicle Headlamp Bracket

(71) Applicant: Evan Hoburg Patak, San Diego, CA (US)

(72) Inventor: Evan Hoburg Patak, San Diego, CA (US)

(21) Appl. No.: 15/488,034

(22) Filed: Apr. 14, 2017

(51) Int. Cl. B60Q 1/04; B60Q 1/06; F16M 13/02; B29C 67/00; B33Y 10/00; B33Y 50/02; B33Y 80/00

(52) U.S. Cl. CPC B60Q 1/0483; B60Q 1/06; F16M 13/02; B29C 67/0062; B29L 2031/30; B33Y 10/00; B33Y 50/02; B33Y 80/00; B60Q 2900/10; B29C 67/0088

(57) ABSTRACT

A retrofit bracket configured to couple a replacement projector to a headlamp housing, and a method for manufacturing the retrofit bracket are provided. The retrofit bracket has housing mounting points for coupling to the headlamp housing and projector mounting points for coupling to the replacement projector. Manufacturing the retrofit bracket includes storing in computer readable memory a model of an original bracket, using data from the model of the original bracket to develop a model of a retrofit bracket, and using data from the model of the retrofit bracket to manufacture the retrofit bracket. A three-dimensional scanner can be utilized to capture information used in the model of the original bracket and the model of the retrofit bracket and a three-dimensional printer, machining, and molding can be utilized to manufacture the retrofit bracket.

### FIELD OF THE INVENTION

The present invention relates generally to vehicle headlamps, more specifically but not by way of limitation, to a retrofit bracket configured to accommodate a replacement projector suitable for use in a specific make and model of vehicle headlamp.

### BACKGROUND

The following description includes information that may be useful in understanding the present invention. It is not an admission that any of the information provided herein is prior art or relevant to the presently claimed invention, or that any publication specifically or implicitly referenced is prior art.

Retrofitting vehicle components is a popular activity practiced by auto enthusiast worldwide. Among the many vehicle components that can be retrofitted are headlamps. Vehicle headlamps are retrofitted for any of many reasons, including to improve visibility or other safety parameters, to improve a vehicle's appearance or esthetics, or to replace damaged or broken components.

Typically, those skilled in the art purchase new or salvaged aftermarket components, which might or might not be direct replacements for the original equipment. Replacing headlamp components, such as a projector, pose difficulties when modifications are needed to accommodate the aftermarket component in the headlamp housing. In some cases, it is necessary to design and make, or modify, a harnesses or bracket to assist in coupling an aftermarket component to the headlamp housing. This process can be time consuming and expensive. Additionally, there is no guarantee that the aftermarket components will work, or will work in the headlamp housing.

Accordingly, it is an aspect of the present invention to provide a method for manufacturing a retrofit bracket, and a retrofit bracket that can be configured to accommodate a replacement projector suitable for use in a specific make and model of vehicle headlamp. The bracket component of a headlamp is typically designed by the original equipment manufacturer (OEM) to connect the OEM headlamp housing to the OEM's selected projector. Thus, the headlamp housing, bracket and projector are narrowly designed features of most vehicle headlamps. In order to accommodate a different aftermarket replacement projector, it becomes necessary to retrofit the bracket in order to accommodate the newly selected replacement projector in the headlamp housing.

Thus, there is still a need for a retrofit bracket that accommodates a different aftermarket replacement projector in the headlamp housing.

### SUMMARY OF THE INVENTION

The inventive subject matter provides a method for manufacturing a retrofit bracket to couple a replacement projector to a headlamp housing. The method comprises storing in a computer readable memory a model of an original bracket. The original bracket comprises housing mounting points configured to couple the original bracket to a headlamp housing, and original projector mounting points configured to couple the original bracket to an original projector. Data from the model of the original bracket is utilized to develop a model of a retrofit bracket. The retrofit bracket comprises housing mounting points configured to couple the retrofit bracket to the headlamp housing, and replacement projector mounting points configured to couple the retrofit bracket to the replacement projector. At least one of the replacement projector mounting points is different from a corresponding one of the original projector mounting points. The model of the retrofit bracket is used by a person or machine, including a three-dimensional printer, or both to manufacture the retrofit bracket.

Another aspect of the present invention is to provide a computer program product comprising a tangible nontransitory computer readable medium having instructions stored thereon that when executed by a computer performs the method recited for manufacturing a retrofit bracket to couple a replacement projector to a headlamp housing.

Yet another aspect of the present invention is to provide a retrofit bracket configured to couple a replacement projector to a headlamp housing. The retrofit bracket comprises housing mounting points configured to couple the retrofit bracket to the headlamp housing and replacement projector mounting points configured to couple the retrofit bracket to the replacement projector. At least one of the replacement projector mounting points is different from a corresponding one of an original projector mounting points.

Although the various steps of the method are described in the above paragraphs as occurring in a certain order, the present application is not bound by the order in which the various steps occur. In fact, in alternative aspects of the present invention, the various steps can be executed in an order different from the order described above or otherwise herein.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In some embodiments of the invention, the structural components illustrated herein are drawn to scale. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 is front perspective view depicting a vehicle having a headlamp;

FIG. 2 is a front view depicting a portion of a headlamp of vehicle 10 of FIG. 1, wherein portions of the vehicle are removed for clarity of illustration;

FIG. 3 is a front view depicting an original projector and an original bracket removed from the headlamp housing of a vehicle;

FIG. 4 is a top view of an original projector and original bracket of FIG. 3, disassembled for clarity of illustration;

FIG. 5 is a top view of a selected replacement projector;

FIG. 6 is a front view of a replacement projector;

FIG. 7 is a front view of a model of an original bracket, according to an aspect of the present invention;

FIG. 8 is a back view of the model of an original bracket of FIG. 7, according to an aspect of the present invention;

FIG. 9 is a view of a model of a replacement projector bowl disassembled for clarity of illustration, according to an aspect of the present invention;

FIG. 10 is a rear view of a model of a retrofit bracket, according to an aspect of the present invention;

FIG. 11 is a front view of a manufactured retrofit bracket and replacement projector, according to an aspect of the present invention;

FIG. 12 is a side view of an assembled retrofit bracket and replacement projector, according to an aspect of the present invention;

FIG. 13 is a top view of ball joint clips;

FIG. 14 is a top view of the back of the retrofit bracket with ball joint clips of FIG. 13 installed, according to an aspect of the present invention;

FIG. 15 is a front view of a headlamp;

FIG. 16 is a front view of the headlamp housing of FIG. 15 showing components; and

FIG. 17 is a side view of a headlamp having a retrofit bracket and replacement projector installed, according to an aspect of the present invention.

### DETAILED DESCRIPTION OF THE DRAWINGS

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

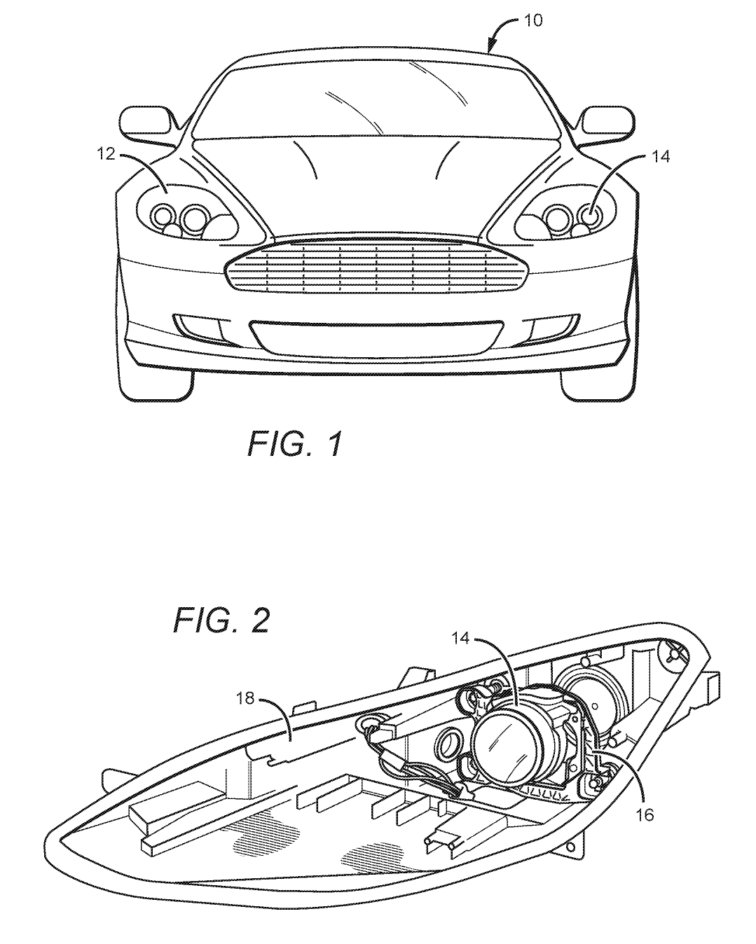

Certain aspects of the present invention are hereinafter described in detail in connection with the views and examples of FIGS. 1-17. A retrofit bracket for use in a vehicle headlamp as described herein can be provided upon any of a variety of suitable vehicles such as, for example, cars, trucks, vans, watercraft, utility vehicles, recreational vehicles, and aircraft. FIG. 1 is front perspective view depicting a vehicle 10 having headlamps 12 each comprising an original projector 14, and an original bracket (not shown). The headlamps 12 are shown to be positioned at a forward end of the vehicle 10. The original projector 14 can include a light source such as one or more light bulbs which can be generally configured to illuminate a roadway or other terrain ahead of the vehicle 10.

FIG. 2 is a front view depicting a portion of a headlamp 12 of vehicle 10 of FIG. 1, wherein portions of the vehicle are removed for clarity of illustration. The original projector 14, original bracket 16, and headlamp housing 18 are shown. The original bracket component 16 of a headlamp 12 is typically designed by the OEM to connect the headlamp housing 18 to the original projector 14.

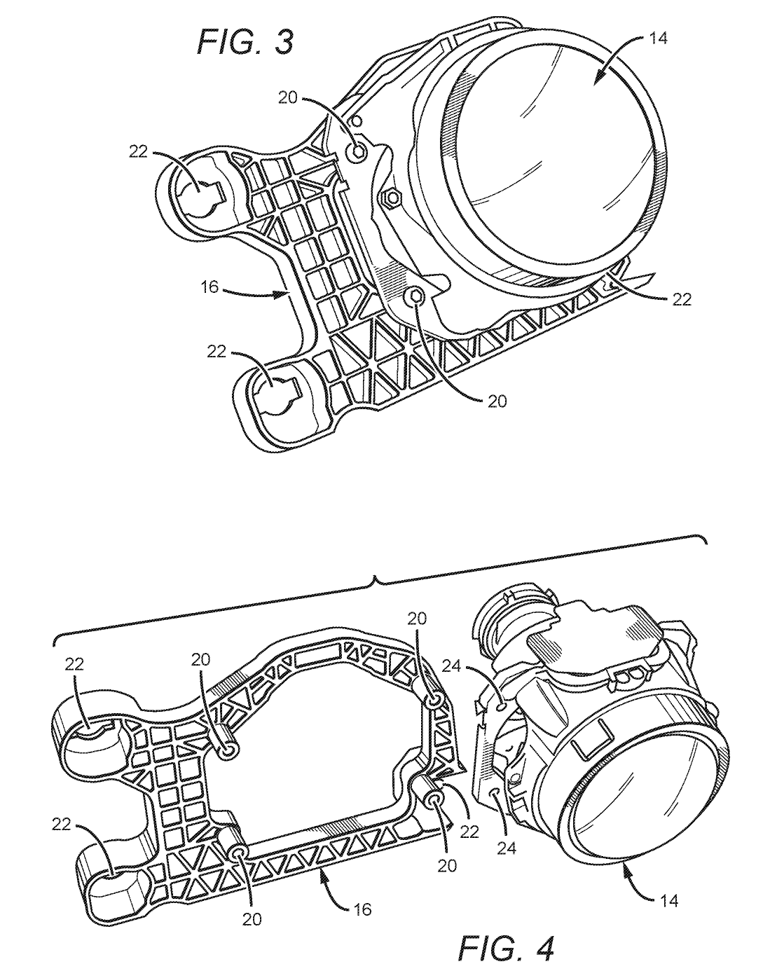

According to an aspect of the present invention, FIG. 3 is a front view depicting the original projector 14, and original bracket 16 removed from the headlamp housing of a vehicle. The original bracket 16 has original projector mounting points 20 configured for mounting the original projector 14 to the original bracket 16. The original bracket 16 additionally has housing mounting points 22 configured to mount the original bracket 16 to the headlamp housing. The original projector 14 and original bracket 16 of FIG. 3, are shown disassembled for clarity of illustration in FIG. 4. The original bracket is configured with housing mounting points 22, and original projector mounting points 20 configured to align with the original projector apertures 24. Thus, the headlamp housing 18 of FIG. 2, original bracket 16, and original projector 14 are narrowly designed features of most vehicle headlamps comprising projectors. Accordingly, the original bracket is configured to accommodate a specific projector suitable for use in a specific make and model of vehicle headlamp.

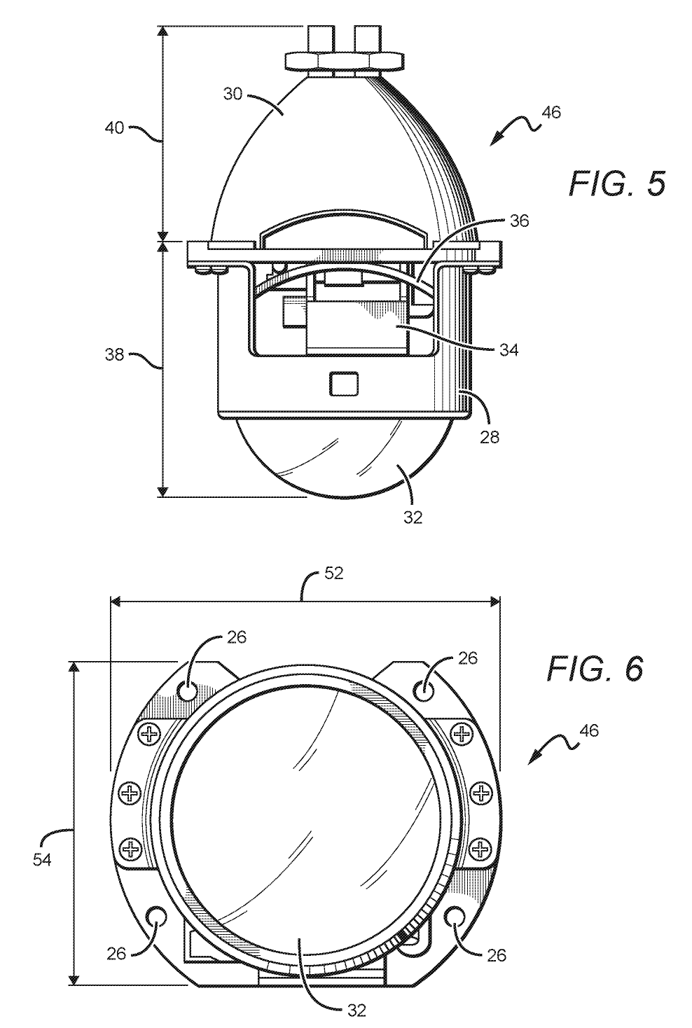

Referring to FIG. 5 a selected replacement projector 46 for retrofitting the vehicle headlamp is shown. Most projectors in current production can combine a halogen, light emitting diodes (LEDs) or High Intensity Discharge (HID) light bulb (not shown) with a lens holder 28, reflective bowl 30, a lens 32, a solenoid 34, and a cutoff shield 36 to control the beam pattern. Projectors can be Xenon and Bi-Xenon. Xenon headlamps employ a cutoff shield that is generally not coupled to a solenoid so that it is not moveable, and is only capable of directing the beam of light to produce a low beam. By contrast, Bi-Xenon headlamps employ a cutoff shield 36 that is generally coupled to a solenoid 34, so that it is moveable, such that when the cutoff shield 36 moves downward a high beam of light is produced and when the cutoff shield moves upward a low beam of light is produced. The projector length 38, measured from the mounting surface of the bracket to the front of the lens 32, and the projector bowl length 40, measured from the mounting surface of the bracket to the back of the reflective bowl, are important in determining if a replacement projector 46 can be accommodated within the headlamp housing.

A front view of a replacement projector 46 is shown in FIG. 6, showing the lens 32, and replacement projector apertures 26, at least one of the replacement projector apertures is different from a corresponding one of the original projector apertures 24 of FIG. 4. The replacement projector width 52 and the replacement projector height 54 are also important in determining if a replacement projector 46 can be accommodated within the headlamp housing. Provided the replacement projector 46 can be accommodated within the headlamp housing, to accommodate the replacement projector 46, it becomes necessary to retrofit the bracket component to couple the replacement projector 46 to the headlamp housing 18 of FIG. 2.

One aspect of the present invention includes storing a model of the original bracket, comprising housing mounting points configured to couple the original bracket to a headlamp housing, and original projector mounting points configured to couple the original bracket to an original projector, in a computer readable memory. It will be appreciated that the model of the original bracket can be developed utilizing any of a number of known technologies such as importing into computer readable memory drawings, photographs, three-dimensional scanned images, and CAD images, utilizing applications for use in design, engineering and manufacturing. Such known technologies typically convert raw data sets into any of a number of data, data files, digital images, Stereo Lithography (STL) and three-dimensional models.

In some aspects the three-dimensional scanner employs some type of optical projection, either laser or structured light, and one or more cameras. It will be appreciated by those skilled in the art, the cameras can be configured to detect pixels along the projected stripes in order to triangulate data points along each stripe. The output from this process in some aspects can be called a “cloud of points”. Point clouds can then be triangulated into a polygon mesh, or STL files. Those skilled in the art will appreciate, an STL file can be suitable for three-dimensional printing.

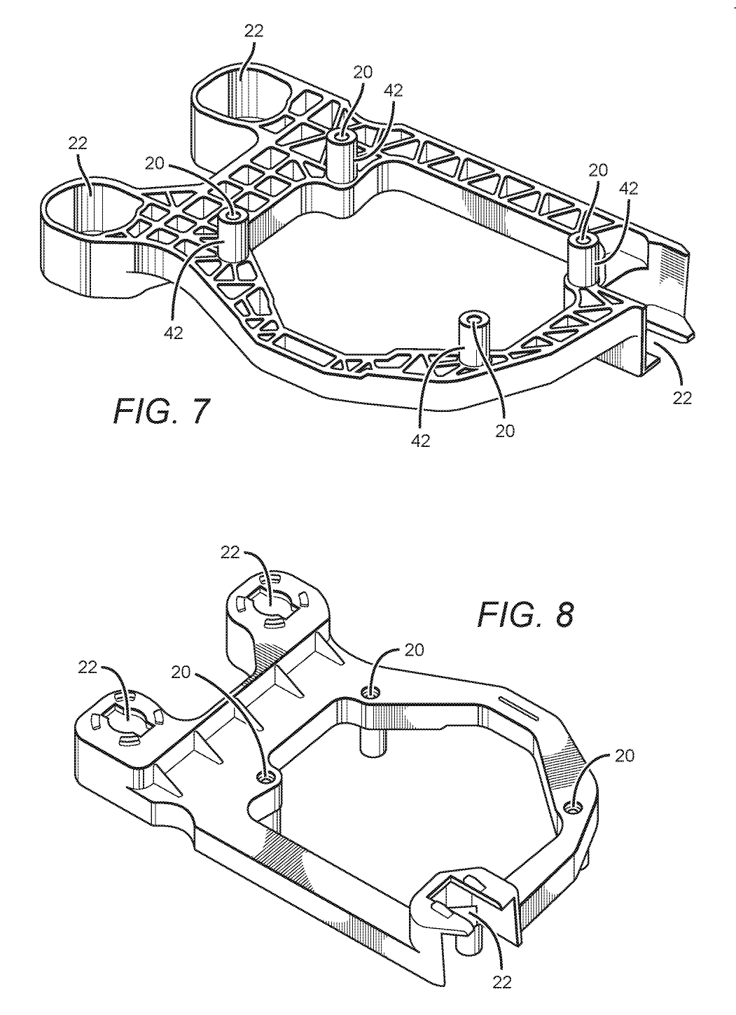

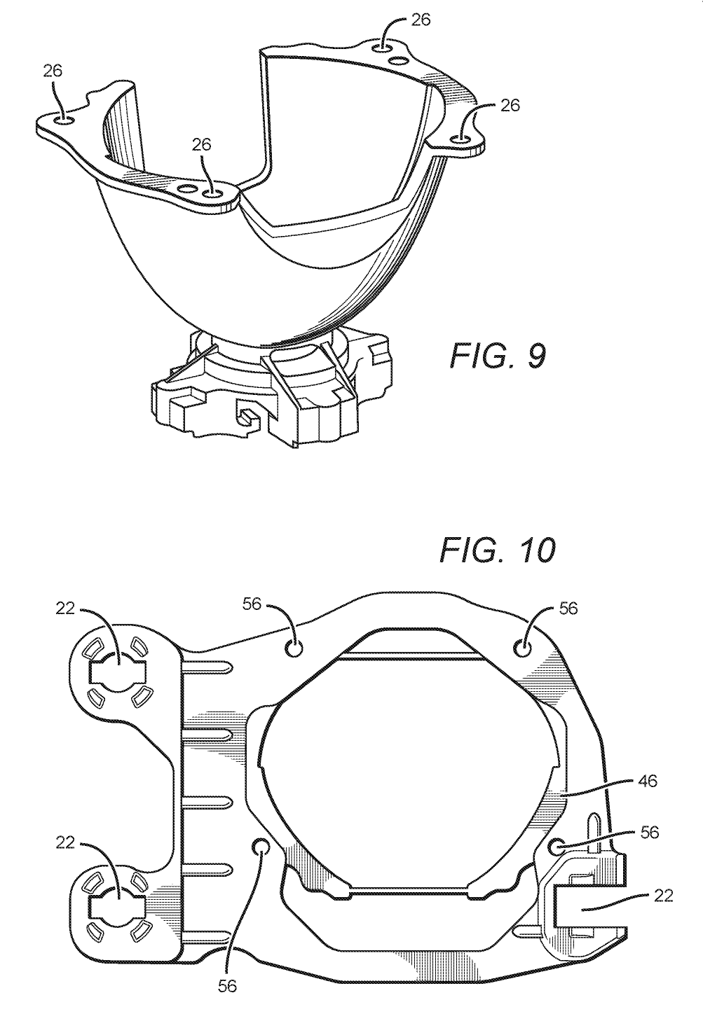

According to an aspect of the present invention, FIG. 7 is a front view of a model of an original bracket 16 having original projector mounting points 20 with spacer regions 42, and housing mounting points 22. FIG. 8 is a back view of the model of an original bracket 16 of FIG. 7, according to an aspect of the present invention, showing the back of the projector mounting points 20 and housing mounting points 22. According to another aspect of the present invention, FIG. 9 is a view of a model of a reflective bowl disassembled for clarity of illustration, showing the replacement projector apertures 26.

One aspect of the present invention includes utilizing data from the model of the original bracket to develop a model of a retrofit bracket. FIG. 10 is a rear view of a model of a retrofit bracket, according to an aspect of the present invention, showing the replacement projector mounting points 56 configured to couple with a replacement projector 46, and housing mounting points 22 configured to couple with the headlamp housing 18 of FIG. 2. Utilizing the replacement projector width and height, the replacement projector mounting points 56 are configured to position the replacement projector 46 at a predetermined location along a vertical and horizontal axis within the headlamp housing 18 of FIG. 2. The replacement projector mounting points can comprise an integrated spacer region configured by utilizing the replacement projector length and the projector bowl length to position the replacement projector at a predetermined depth within the headlamp housing 18 of FIG. 2.

In one aspect, the model of the replacement projector bowl as in FIG. 9 is utilized in conjunction with the model of the original bracket to assist in developing a model of a retrofit bracket as in FIG. 10 comprising replacement projector mounting points that align with the replacement projector apertures. In some aspects, the model of the retrofit bracket, which can be stored in computer readable memory, is utilized to manufacture a retrofit bracket. It will be appreciated by those skilled in the art, that any number of known software tools and techniques can be used to convert models, such as STL files, into articles comprising a variety of different photopolymer materials. In some aspects, the retrofit bracket can be manufactured in a variety of different photopolymer materials, nylon, wood, plastic, ceramic, metal, and glass.

In other aspects, rapid prototyping, three-dimensional printing and computer-aided manufacturing technologies can be utilized to manufacture a retrofit bracket. Stereolithography is a form of three-dimensional printing technology used for creating models, prototypes, patterns, and production parts in a layer by layer fashion using photopolymerization, a process by which light causes chains of molecules to link together, forming polymers. Those polymers then make up the body of a three-dimensional solid. U.S. Pat. No. 5,184,307 entitled “Method and apparatus for production of high resolution three-dimensional objects by stereolithography,” which is hereby incorporated by reference as though set forth in full herein, describes stereolithography systems that can be employed by those skilled in the art to manufacture the retrofit bracket. It should be appreciated that other methods can be employed for manufacturing the retrofit bracket such as machining, and molding.

In one aspect, the method of manufacturing a retrofit bracket is implemented as a series of instructions stored on a tangible, nontransitory computer-readable medium and capable of being executed by a computer. A computer for implementing the method, according to an aspect of the present invention, comprises a processor (e.g., one or more processors), and a memory in communication with the processor. The computer may further include an input device for inputting data (such as keyboard, a mouse or the like) and an output device such as a display device for displaying results of the computation.

As it can be appreciated, the term “computer” is used herein to encompass any type of computing system or device including a personal computer (e.g., a desktop computer, a laptop computer, or any other handheld computing device), or a mainframe or supercomputer, or a plurality of networked computers in a distributed computing environment. For example, the method may be implemented as a computer program product such as a software program application which can be stored in a computer readable medium such as hard disks, CDROMs, optical disks, DVDs, magnetic optical disks, RAMs, EPROMs, EEPROMs, magnetic or optical cards, flash cards (e.g., a USB flash card), PCMCIA memory cards, smart cards, or other media. It will be appreciated that the scope and underlying principles of the present invention are not limited to any particular computer software or hardware technology.

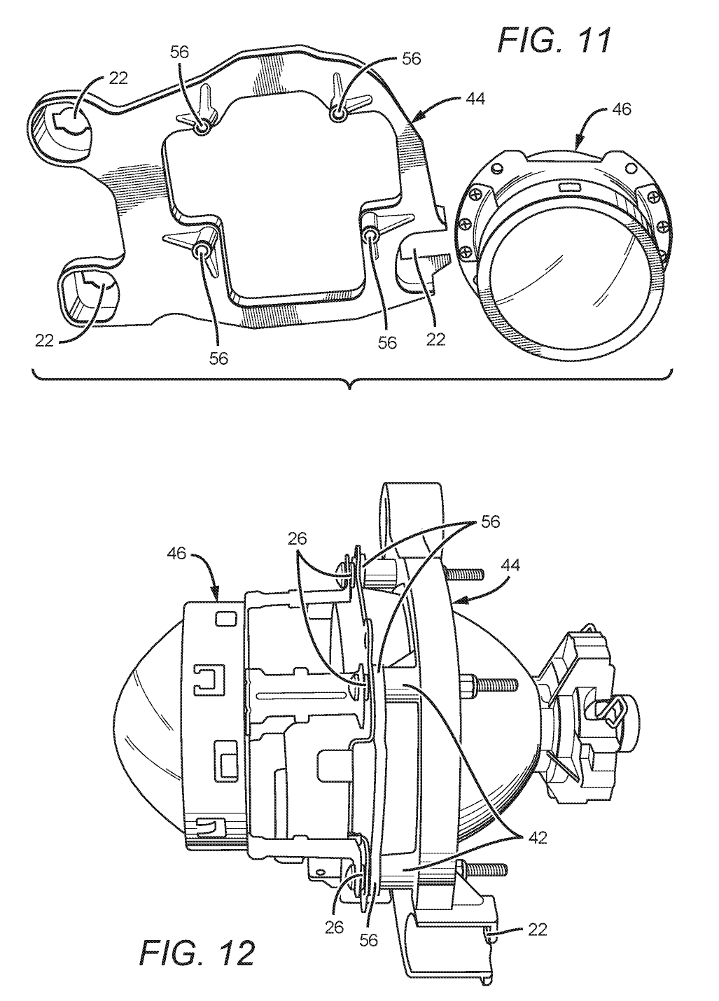

According to an aspect of the present invention, FIG. 11 is a front view of a manufactured retrofit bracket 44 and a replacement projector 46. The retrofit bracket comprises housing mounting points 22 configured to couple the retrofit bracket 44 to the headlamp housing, and replacement projector mounting points 56 configured to couple the retrofit bracket 44 to the replacement projector 46. In some aspects, the replacement projector mounting points are configured by utilizing the replacement projector width and height to position the replacement projector 46 at a predetermined location along a vertical and horizontal axis within the headlamp housing. The projector mounting points comprise an integrated spacer region 42 configured by utilizing the projector length and the projector bowl length to position the replacement projector at a predetermined depth within the headlamp housing.

FIG. 12 is a side view of an assembled retrofit bracket 44 and replacement projector 46. The replacement projector mounting points 56 are configured to align with the replacement projector apertures 26, the retrofit bracket spacer regions 42 are configured to optimally position the retrofit projector within the headlamp housing, and the housing mounting points 22 are configured to couple the retrofit bracket to the headlamp housing. To facilitate attachment of the replacement projector 46 to the retrofit bracket, a threaded end of a bolt passes through each of the replacement projector apertures 26 and a corresponding replacement projector mounting points 56 on the retrofit bracket 44, and twisted (e.g. with a screwdriver or wrench) to facilitate tightening the bold with a nut as shown in FIG. 12.

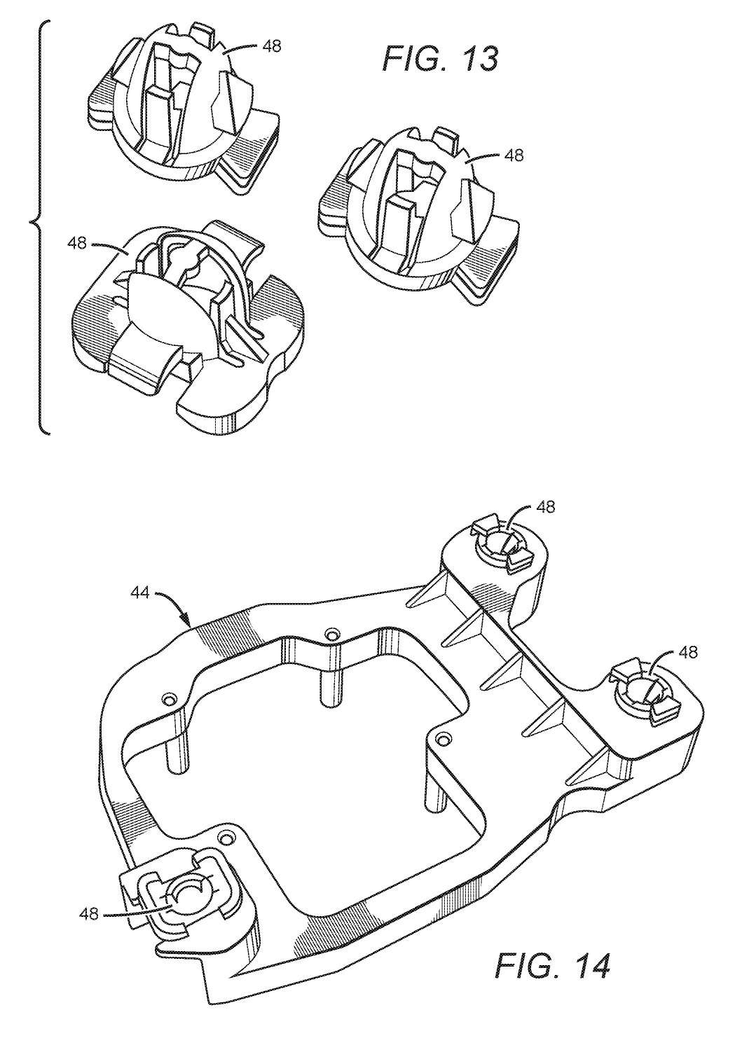

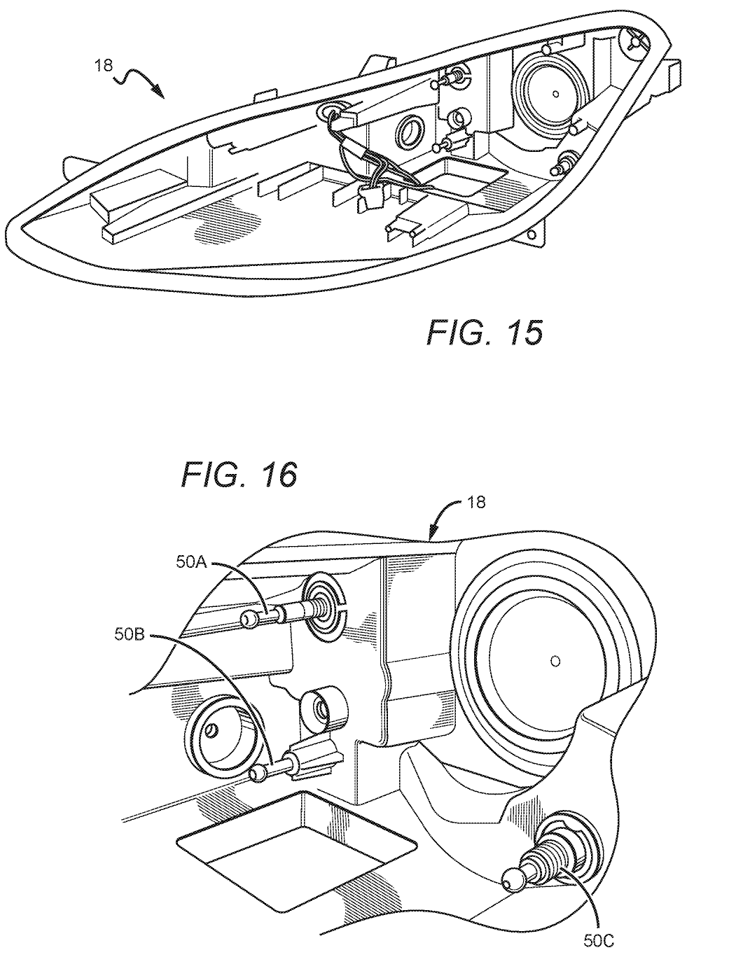

According to an aspect of the present invention, FIG. 13 is a top view of ball joint clips 48, removed from the original bracket and transferred to the retrofit bracket. FIG. 14 is a top view of the back of the retrofit bracket 44 with ball joint clips 48 of FIG. 13 installed, according to an aspect of the present invention. FIG. 15 is a front view of a headlamp housing 18 with the bracket and projector removed, according to an aspect of the present invention.

In yet another aspect of the present invention, FIG. 16 is a front view of the headlamp housing 18 of FIG. 15 showing the housing mounting joints 50A, 50B, and 50C. Mounting joints 50A, 50B, and 50C are shown as ball joints, and mounting joints 50A and 50C are shown as threaded which can allow the up/down, and left/right adjustments. To facilitate mounting of the coupled retrofit bracket and replacement projector, the housing mounting points on the retrofit bracket are aligned with the mounting points on the headlamp housing of the vehicle, and forcibly snapped into place. Those skilled in the art, will appreciate the foregoing aspects provide a retrofit bracket comprising a pivoted joint configured to allow rotation about a single axis, often referred to as a gimbal. When coupled to the headlamp housing, the retrofit bracket coupled to the replacement projector can pivot about a generally horizontal axis a generally vertical axis.

Those skilled in the art will appreciate the present invention can provide retrofit brackets in a variety of suitable configurations. Each suitable configuration capable of accommodating a different aftermarket replacement projector suitable for use in a specific make and model of vehicle headlamp housing. In some aspects of the present invention, suitable configurations can include having any number of housing mounting points and any number of projector mounting points, each capable of any of a number of configurations for coupling, such as ball joints, pivot joints and fixed joints

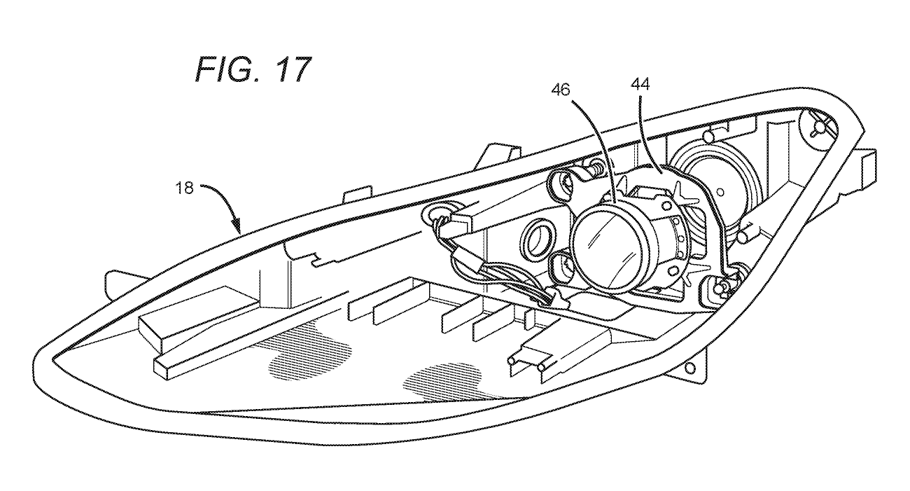

FIG. 17 is a side view of a headlamp housing 18 having a retrofit bracket 44 and replacement projector 46 installed, according to an aspect of the present invention. In most headlamps, the projector lens resides in close proximity to the headlamp trim as shown, further illustrating the importance of the retrofit bracket design to position the replacement projector in an orientation extremely similar to the original projector. If overlooked, the projector would not physically fit within the headlamp house, would look out of place, or prevent the projector from operating safely, reducing illumination of a roadway ahead of the vehicle.

The foregoing description of aspects of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The aspects were chosen and described in order to best illustrate the principles of the invention and various aspects as are suited to the particular use contemplated. The scope of the invention is, of course, not limited to the aspects set forth herein, but can be employed in any number of applications and equivalent devices by those of ordinary skill in the art. Rather it is hereby intended the scope of the invention be defined by the claims appended hereto.

What is claimed is:

1. A method for manufacturing a retrofit bracket to couple a replacement projector to a headlamp housing, the method comprising:
storing in a computer readable memory a model of an original bracket comprising: housing mounting points configured to couple the original bracket to a headlamp housing, and original projector mounting points configured to couple the original bracket to an original projector;
utilizing data from the model of the original bracket to develop a model of a retrofit bracket comprising: housing mounting points configured to couple the retrofit bracket to the headlamp housing, and replacement projector mounting points configured to couple the retrofit bracket to the replacement projector; wherein, at least one of the replacement projector mounting points is different from a corresponding one of the original projector mounting points; and
using the model of the retrofit bracket to manufacture the retrofit bracket.

2. The method of claim 1, further comprising using a three-dimensional scanner to capture information used in the model of the original bracket.

3. The method of claim 1, further comprising using a three-dimensional scanner to capture information used in the model of the retrofit bracket.

4. The method of claim 1, wherein at least one of the model of the original bracket and model of the retrofit bracket comprises digital data files.

5. The method of claim 1, wherein at least one of the model of the original bracket and model of the retrofit bracket comprises digital images.

6. The method of claim 1, wherein at least one of the model of the original bracket and model of the retrofit bracket comprises Stereo Lithography files.

7. The method of claim 1, wherein the replacement projector comprises a hi-xenon projector.

8. The method of claim 1, wherein the replacement projector mounting points configured to couple the retrofit bracket to the replacement projector are configured to position the replacement projector at a predetermined location along a vertical and horizontal axis within the headlamp housing.

9. The method of claim 1, wherein the replacement projector mounting points configured to couple the retrofit bracket to the replacement projector comprise an integrated spacer region configured to position the selected projector at a predetermined depth within the headlamp housing.

10. The method of claim 1, wherein at least one of the housing mounting points configured to couple the retrofit bracket to the headlamp housing is a pivoted joint configured to move about an axis.

11. The method of claim 1, wherein at least one of the housing mounting points configured to couple the retrofit bracket to the headlamp housing is adjustable.

12. The method of claim 1, wherein the step of using the model of the retrofit bracket to manufacture the retrofit bracket is performed by a three-dimensional printer.

13. The method of claim 1, wherein manufacturing the retrofit bracket comprises at least one component selected from the group consisting of three-dimensional printing, machining, and molding.

14. The method of claim 1, wherein the retrofit bracket comprises at least one component selected from the group consisting of photopolymer materials, nylon, wood, plastic, ceramic, metal, and glass.

15. A computer program product comprising a tangible nontransitory computer readable medium having instructions stored thereon that when executed by a computer performs the method recited in claim 1.

16. A retrofit bracket configured to couple a replacement projector to a headlamp housing, the retrofit bracket comprising:
a housing mounting point configured to couple the retrofit bracket to the headlamp housing; and
a replacement projector mounting point configured to couple the retrofit bracket to the replacement projector; wherein, at least one of the replacement projector mounting points is different from a corresponding one of an original projector mounting points.

17. The retrofit bracket of claim 15, wherein the replacement projector comprises a hi-xenon projector.

18. The retrofit bracket of claim 15, wherein the replacement projector mounting point is configured to position the replacement projector at a predetermined location along a vertical and horizontal axis within the headlamp housing.

19. The retrofit bracket of claim 15, wherein the replacement projector mounting point comprises an integrated spacer region configured to position the replacement projector at a predetermined depth within the headlamp housing.

20. The retrofit bracket of claim 15, wherein at least one of the housing mounting points configured to couple the retrofit bracket to the headlamp housing is a pivoted joint configured to move about an axis.

21. The retrofit bracket of claim 15, wherein at least one of the housing mounting points configured to couple the retrofit bracket to the headlamp housing is adjustable.

22. The retrofit bracket of claim 15, wherein the retrofit bracket comprises at least one component selected from the group consisting of photopolymer materials, nylon, wood, plastic, ceramic, metal, and glass.
